(19) United States
(12) Patent Application Publication
(10) Pub. No.: US 2025/0052000 A1
(43) Pub. Date: Feb. 13, 2025

(54) CARPET COMPONENTS CONTAINING INDIVIDUALLY DISPERSED FIBERS AND METHODS OF MAKING THE SAME

(71) Applicant: ALADDIN MANUFACTURING CORPORATION, Calhoun, GA (US)

(72) Inventors: Harlan MORRIS, Calhoun, GA (US); Erika MORENO, Calhoun, GA (US); Carlos CARRILLO, Calhoun, GA (US)

(21) Appl. No.: 18/723,126

(22) PCT Filed: Dec. 9, 2022
(86) PCT No.: PCT/IB2022/061964

§ 371 Date: Jun. 21, 2024

Related U.S. Application Data
(60) Provisional application No. 63/265,964, filed on Dec. 23, 2021.

(51) Int. Cl. D06N 7/00

(52) U.S. Cl. CPC D06N 7/0076; D06N 7/0068; D06N 2203/042; D06N 2205/14

(57) ABSTRACT

A carpet or carpet tile containing a plurality of individually dispersed fibers and processes for making the same, wherein the carpet or carpet tile comprises a facecloth and a polymer sheet. The polymer sheet comprises a polymer-based resin and a plurality of individually dispersed fibers and may be formed by applying the plurality of individually dispersed fibers onto the facecloth's primary backing, or optionally, onto a polymer coating disposed on the facecloth's primary backing and extruding the polymer-based resin onto the plurality of individually dispersed fibers, or by incorporating the plurality of individually dispersed fibers into the polymer-based resin and extruding the mixture onto the primary backing.

### BACKGROUND

The installation techniques traditionally used to install modular carpet components such as carpet tiles puts a large emphasis on the need to ensure that each component is individually flat when installed. Whereas the edges of larger broadloom carpet installations may be positioned adjacent walls and/or may be specifically pinned to a subfloor, the edges of at least some smaller carpet tiles are generally exposed (possibly in the center of a room or high-traffic area) and may not be directly secured relative to their respective neighboring tiles. Thus, manufacturers of carpet tiles must ensure that these tiles do not curl (such that the carpet tile edges curl upward away from the subfloor) or dome (such that the middle of the carpet tile moves upward away from the subfloor) once installed. Each of these possible defects may create trip hazards for individuals walking along the tiled floor or may create unsightly gaps between adjacent tiles. Even when each carpet tile is individually secured to the underlying subfloor (e.g., via an adhesive), internal forces within the carpet tile tending to curl or dome may cause portions of the tile to break away from the adhesive and the subfloor.

Accordingly, a need exists for low-weight and durable carpet having desirable flatness characteristics.

In the known art, lower weight carpet is manufactured by applying a latex layer to the bottom of the facecloth, followed by webbed fibers, which are encapsulated by a polymer layer. The disclosure herein is an improvement over this known method because the use of individualized fibers minimizes curling of the carpet.

### BRIEF SUMMARY

Various embodiments are directed to a carpet or carpet tile comprising a facecloth, wherein a top side of the facecloth defines an upper surface of the carpet or carpet tile; and a polymer sheet, wherein a polymer sheet encapsulates a plurality of individually dispersed fibers and defines at least a portion of a bottom surface of the carpet or carpet tile.

Various embodiments are directed to a carpet or carpet tile wherein a plurality of individually dispersed fibers are encapsulated by a polymer sheet and where those fibers are configured with their length direction substantially parallel to the plane of the polymer sheet.

In some embodiments, the plurality of individually dispersed fibers comprises glass fibers. In some embodiments, the plurality of individually dispersed fibers comprises polymer fibers. In some embodiments, the plurality of individually dispersed fibers are polymer fibers. In some embodiments, the plurality of individually dispersed fibers comprise chopped fiberglass. In some embodiments, the plurality of individually dispersed fibers consist of chopped fiberglass.

In various embodiments, the plurality of individually dispersed fibers are at least 0.5 inches in length. In some embodiments, the plurality of individually dispersed fibers are at least 1 inch in length. In some embodiments, the plurality of individually dispersed fibers are at least 1.5 inches in length.

In various embodiments, the carpet comprises a polymer coating, which is present in between the facecloth and the polymer sheet. In some embodiments, the polymer coating comprises one or more polyolefins. In some embodiments, the polyolefins have repeating units selected from the groups consisting of propylene, ethylene, butene, and combinations thereof.

In various embodiments, the polymer sheet and the bottom side of the facecloth are between 0.01 and 20 mm apart. In various embodiments, the polymer sheet has a thickness of between 0.01 and 20 mm. In various embodiments, the polymer sheet and the primary backing are positioned at most 10 mm apart from one another.

In various embodiments, the polymer sheet is an extruded polymer sheet. In some embodiments, the polymer sheet comprises one or more polyolefins. In some embodiments, the polymer sheet comprises one or more repeating polyolefins selected from the group consisting of propylene, ethylene, butene, and combinations thereof.

In various embodiments, the facecloth comprises a woven material.

Certain embodiments are directed to a method of manufacturing carpet or carpet tile, the method comprising providing a facecloth, said facecloth having a top side and a bottom side; applying a polymer coating to the bottom side of the facecloth, so that the polymer coating has a top side and a bottom side, wherein said top side is in contact with the facecloth; applying a plurality of individually dispersed fibers to the bottom coating; and extruding a polymer based resin onto the bottom side of the polymer coating, thereby encapsulating the plurality of individually dispersed fibers.

In various embodiments, the carpet or carpet tile is manufactured by a method comprising providing a facecloth having a top side and a bottom side, applying a polymer coating to the bottom side of the facecloth so that the polymer coating has a top side and a bottom side wherein said top side is in contact with the facecloth, applying a plurality of individually dispersed fibers to the bottom side of the polymer coating, and extruding a polymer-based resin onto the bottom side of the polymer coating, thereby encapsulating the plurality of individually dispersed fibers.

In certain embodiments, the polymer coating comprises one or more polyolefins. In certain embodiments, said polyolefins comprise repeating units selected from the group consisting of propylene, ethylene, butene, and combinations thereof.

In various embodiments, the method of manufacturing a carpet or carpet tile comprises providing a facecloth having a top side and a bottom side and extruding a polymer-based resin comprising individually dispersed fibers onto the bottom side of the facecloth, thereby forming a polymer sheet comprising a plurality of individually dispersed fibers.

In an alternative embodiment, the method of manufacturing a carpet or carpet tile comprises providing a facecloth, said facecloth having a top side and a bottom side; applying a polymer coating to the bottom side of the facecloth, so that the polymer coating has a top side and a bottom side, wherein said top side is in contact with the facecloth, and applying a polymer-based resin containing individually dispersed fibers onto the bottom side of the polymer coating thereby forming a polymer sheet comprising a plurality of individually dispersed fibers.

As used herein, the term “polymer sheet” comprises both a polymer-based resin and a plurality of individually dispersed fibers.

### BRIEF DESCRIPTION OF THE SEVERAL VIEWS OF THE DRAWINGS

Reference will now be made to the accompanying drawings, which are not necessarily drawn to scale, and wherein:

FIG. 1 is a cross-sectional view showing various components of a carpet according to one embodiment wherein the facecloth is tufted;

FIG. 2 is a cross-sectional view showing various components of a carpet according to an embodiment wherein the facecloth is woven;

FIG. 3 is a schematic diagram of a portion of a manufacturing line utilized to produce carpet or tiles according to an embodiment;

FIG. 4 is a schematic diagram of a portion of a manufacturing line utilized to produce carpet or carpet tiles according to an embodiment;

FIG. 5 is a flowchart showing various steps involved in production of a carpet according to various embodiments; and

FIG. 6 is a flowchart showing various steps involved in production of a carpet according to various embodiments.

### DETAILED DESCRIPTION

The present disclosure more fully describes various embodiments with reference to the accompanying drawings. It should be understood that some, but not all embodiments are shown and described herein. Indeed, the embodiments may take many different forms, and accordingly this disclosure should not be construed as limited to the embodiments set forth herein. Rather, these embodiments are provided so that this disclosure will satisfy applicable legal requirements. Like numbers refer to like elements throughout. In the following description, various components may be identified as having specific values or parameters, however, these items are provided as exemplary embodiments. Indeed, the exemplary embodiments do not limit the various aspects and concepts of the embodiments as many comparable parameters, sizes, ranges, and/or values may be implemented. The terms “first,” “second,” and the like, “primary,” “exemplary,” “secondary,” and the like, do not denote any order, quantity, or importance, but rather are used to distinguish one element from another. Further, the terms “a,” “an,” and “the” do not denote a limitation of quantity, but rather denote the presence of “at least one” of the referenced item.

Each embodiment disclosed herein is contemplated as being applicable to each of the other disclosed embodiments. All combinations and sub-combinations of the various elements described herein are within the scope of the embodiments.

It is understood that where a parameter range is provided, all integers and ranges within that range, and tenths and hundredths thereof, are also provided by the embodiments. For example, “5-10” includes 5, 6, 7, 8, 9, and 10; 5.0, 5.1, 5.2 . . . 9.8, 9.9, and 10.0; and 5.00, 5.01, 5.02 . . . 9.98, 9.99, and 10.00, as well as, for example, 6-9, 5.1-9.9, and 5.01-9.99.

Various embodiments are directed to a carpet tile that is resistant to both doming and curling. The carpet or carpet tile is multi-layer and comprises a facecloth having a bottom side and a top side, with a polymer sheet disposed on the bottom side of the facecloth (or, optionally, with a polymer coating between the bottom side of the facecloth and the polymer sheet). The polymer sheet is prepared from a polymer-based resin and comprises or encapsulates a plurality of individually dispersed fibers. Without being bound by theory, it is believed that curling of the carpet can be reduced by using individually dispersed fibers because they will lay more closely to the facecloth than the fiberglass materials currently known in the art.

### Carpet or Carpet Tile

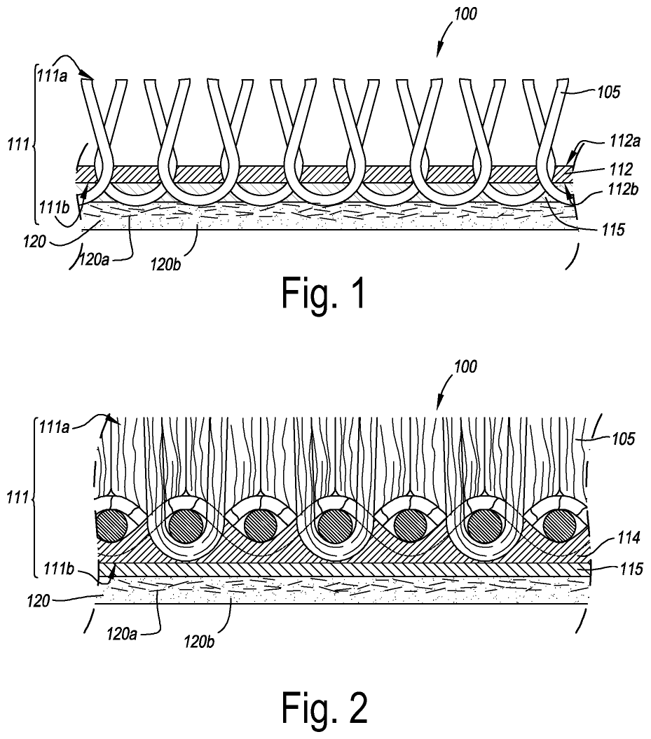

Referring to the figures, in which like numerals refer to like elements throughout the several figures, FIG. 1 is a cross sectional view of a carpet 100 in accordance with various embodiments of the present invention. In the illustrated embodiment, the carpet 100 includes a facecloth 111 having a top side 111a and a bottom side 111b. In the pictured embodiment, said facecloth 111 comprises face yarn 105 tufted through the top side 112a of a primary backing 112 and extending from the top side of the primary backing 112. The face yarn 105 may be made from various materials, both natural and synthetic, such as nylon, cotton, wool, nylon, acrylic, polyester, polyamides, polypropylene, and other polyolefins. The bottom side 111b of the facecloth 111 (made in part from the bottom side 112b of the primary backing 112) may be in contact with a polymer coating 115, as pictured, or may be directly in contact with a polymer sheet 120 comprising polymer-based resin 120b and a plurality of individually dispersed fibers 120a (embodiment not pictured).

FIG. 2 is a cross sectional view of a carpet 100 in accordance with alternative embodiments of the present invention. In the illustrated embodiment, the carpet 100 includes a facecloth 111 having a top side 111a and a bottom side 111b. In this embodiment, the facecloth 111 does not comprise face yarns tufted through a primary backing, but is instead a woven facecloth. In certain embodiments, the bottom side 111b may comprise a low melt polyester material 114 configured to bind the various fibers together upon application of heat to the bottom portion. The bottom side 111b of the facecloth 111 (or the low-melt polyester material 114, if present) may be in contact with a polymer coating 115, as pictured, or may be directly in contact with a polymer sheet 120 comprising polymer-based resin 120b and a plurality of individually dispersed fibers 120a (embodiment not pictured).

In FIG. 2, the facecloth 111 may be formed from a substrate such as a woven substrate, a tape yarn substrate, and/or other substrate construction that imparts stability to the carpet or carpet tile 100. The substrate may be made from a polyester, such as poly(ethylene terephthalate) [PET], poly(trimethylene terephthalate) [PTT], poly(butylene terephthalate) [PBT], poly(ethylene terephthalate-co-isophthalate), poly(ethylene naphthalenedicaroxylate) [PEN], and copolymers thereof, and/or combinations thereof, with PET being preferred.

The substrate may also comprise sheathed fibers, which may comprise a polyester core surrounded by a polyamide and/or polyolefin sheath. Typically, the polyester core may be made from PET, PTT, PBT, PEN, poly(ethylene terephthalate-co-isophthalate) and copolymers thereof. The polyamide sheath may be made from polycaprolactam [nylon 6], poly(7-heptanamide) [nylon 7], polycapryllactam [nylon 8], poly(9-nonanamide) [nylon 9], poly(tetramethylene adipamide) [nylon 4,6], poly(hexamethylene adipamide) [nylon 6,6], poly(methylene-4,4′-dicyclohexylene dodecanediamede), poly(1,4-cyclohexylenedimethulene suberamide), poly(m-phenylene isophthalamide), and poly(p-phenylene terephthalamide), with polycaprolactam [nylon 6] being the preferred polyamide. In certain embodiments, the bottom side 111b of the facecloth 111 may be formed using any conventional natural or synthetic material, such as cotton, jute, rayon, paper, nylon, polypropylene and other polyolefins, polyamides, polyesters, and the like.

Optionally, the bottom side 111b of the facecloth 111 may be in contact with a polymer coating 115. In such embodiments, the polymer coating is between the bottom side 111b of the facecloth 111 and the polymer sheet 120. In such embodiments, the polymer coating 115 may be present or applied in the range of approximately 0.1 ounces per square yard to approximately 30 ounces per square yard.

Disposed on the bottom side 111b of the facecloth 111 is a backing construction comprising a polymer sheet 120. The backing construction is arranged such that the polymer-based resin 120b encapsulates a plurality of individually dispersed fibers 120a thereby forming a polymer sheet.

In some embodiments, the plurality of individually dispersed fibers 120a is scattered onto the bottom side 111b of the facecloth 111 while the facecloth 111 is inverted, and the polymer-based resin 120b is then extruded onto the bottom side 111b of the facecloth 111. This results in embodiments including those depicted in FIGS. 1 and 2, in which the individually dispersed fibers 120a are not distributed uniformly throughout the polymer sheet 120, but are concentrated in a portion of the polymer sheet 120 closest to the facecloth 111 (i.e., the top half of the polymer sheet 120).

In some embodiments, ≥60%, ≥70%, ≥80%, ≥85%, ≥90%, ≥91%, ≥92%, ≥93%, ≥94%, ≥95%, ≥96%, ≥97%, ≥98%, ≥99%, ≥99.5%, ≥99.9%, or 100% of the individually dispersed fibers are in the top half of the polymer sheet 120. In some embodiments, ≥50%, ≥60%, ≥70%, ≥80%, ≥85%, ≥90%, ≥91%, ≥92%, ≥93%, ≥94%, ≥95%, ≥96%, ≥97%, ≥98%, ≥99%, ≥99.5%, ≥99.9%, or 100% of the individually dispersed fibers are in the top quarter of the polymer sheet 120. In some embodiments, ≥50%, ≥60%, ≥70%, ≥80%, ≥85%, ≥90%, ≥91%, ≥92%, ≥93%, ≥94%, ≥95%, ≥96%, ≥97%, ≥98%, ≥99%, ≥99.5%, ≥99.9%, or 100% of the individually dispersed fibers are in the top quartile of the polymer sheet 120. In some embodiments, ≥50%, ≥60%, ≥70%, ≥80%, ≥85%, ≥90%, ≥91%, ≥92%, ≥93%, ≥94%, ≥95%, ≥96%, ≥97%, ≥98%, ≥99%, ≥99.5%, ≥99.9%, or 100% of the individually dispersed fibers are in the top quintile of the polymer sheet 120. In some embodiments, ≥50%, ≥60%, ≥70%, ≥80%, ≥85%, ≥90%, ≥91%, ≥92%, ≥93%, ≥94%, ≥95%, ≥96%, ≥97%, ≥98%, ≥99%, ≥99.5%, ≥99.9%, or 100% of the individually dispersed fibers are in the top decile of the polymer sheet 120.

In some embodiments, the plurality of individually dispersed fibers 120a are incorporated into a polymer-based resin before the polymer-based resin is applied to the bottom side of the facecloth 111b to form the polymer sheet 120.

Each of the fibers comprising the plurality of individually dispersed fibers 120a are configured with their length direction substantially parallel to the plane of the polymer sheet. This configuration allows the facecloth to lie extremely close to the polymer sheet, resulting in a flat overall appearance without substantial doming (a central portion of the carpet or carpet tile 100 rising relative to the edges such that a top surface of the carpet or carpet tile 100 is convex) or curling (the edges of the carpet or carpet tile 100 rising relative to the central portion such that its top surface is concave).

The plurality of individually dispersed fibers may comprise chopped fiberglass, glass fibers, polymer fibers, or glass fibers and polymer fibers. Said fibers may be at least about 0.5 inches, 1.0 inches, 1.5 inches, 2.0 inches, 2.5 inches, or 3.0 inches in length. In embodiments, the fibers are from about 0.5 inches to about 3.5 inches in length, or from about 1.0 inches to about 3.0 inches in length, or from about 1.5 inches to about 2.5 inches in length. The plurality of individually dispersed fibers may be present in an amount greater than 0 ounces per square yard but less than or equal to about 30 ounces per square yard (about 1,017 grams per square meter).

The polymer sheet 120 may comprise a polyolefin or a mixture of one or more polyolefins together with one or more other polymers. In various embodiments, the polymer sheet comprises polyolefins having repeat units selected from the group consisting of propylene, ethylene, butene, and combinations thereof. For example, the resin may comprise polyethylene and/or polypropylene. As specific examples, the polyolefin polymer is embodied as repeating units of propylene, ethylene, butene, and combinations thereof. In certain embodiments, the resin of the extruded polymer sheet 120 comprises the polyolefin or polyolefin mixture. In an embodiment, the polymer sheet 120 is present in a weight of about 8-35 ounces per square yard (about 271-1188 grams per square meter).

The polymer sheet 120 may additionally comprise one or more additives, such as an inert filler material, a colorant, an antioxidant, a tackifier, a viscosity modifier, a flame retardant, and/or the like. The inert filler material may function as a low-cost material that adds weight to the polymer sheet 120 to aid in forming an at least substantially flat carpet tile 100.

The inert filler material may be present in an amount between about 0.1% and about 80% by weight of the polymer sheet.

The inert filler material may be made from carbonates such as calcium carbonate (CaCO₃), cesium carbonate (CsCO₃), strontium carbonate (SrCO₃), and magnesium carbonate (MgCO₃); sulfates such as barium sulfate (BaSO₃); oxides such as iron oxide (Fe₂O₃ or Fe₃O₄), aluminum oxide (Al₂O₃), tungsten oxide (WO₃), titanium oxide (TiO₂), silicon oxide (SiO₂); silicates, such as clay; metal salts; fly ash and the like.

Additionally, the inert filler material may be made from post-consumer products, such as post-consumer glass, post-consumer carpets and/or other post-consumer recycled materials. In cases where the inert filler is made from post-consumer glass, the post-consumer glass is ground into powder before it is added as filler, rendering it distinct from the individually dispersed fibers discussed hereinabove. The glass cullet may be made from automotive and architectural glass, also known as plate glass, flint glass, E glass, borosilicate glass, brown glass (bottle glass), green glass (bottle glass), and coal fly ash, or a combination thereof. In the case where post-consumer carpet is used as the inert filler material, the post-consumer carpet maybe ground into a fine cullet and added to the hot melt adhesive. In addition to the post-consumer carpet, remnants and trimmings of carpet (e.g., comprising trim waste from cutting carpet tiles from rolls of carpet, sometimes referred to as window waste), fine waste fibers that are a result of the shearing process, and the like, that are produced as a by-product during the manufacturing process may also be used to form the inert filler material.

The filled or unfilled polymer may also contain a colorant, such as carbon black or another colorant(s) to provide color and increase the opaqueness of the polymer sheet 120. Typically, the colorant may be present in an amount less than or equal to approximately 1 weight percent of the polymer sheet 120. For example, the colorant may be present in an amount between about 0.1-0.5 weight percent of the polymer sheet 120. As a specific example, the colorant may be present in an amount of approximately 0.1 weight percent of the resin and/or the polymer sheet 120.

Moreover, to reduce the possibility of thermo-oxidation degradation, the polymer may also contain one or more antioxidants. Some suitable antioxidants include, but are not limited to amines, 2,2′-methylene bis-(4-methyl-6-tert-butylphenol), 2,4,6-tri-tert-butylphenol, 2,6-di-tert-butyl-4-methylphenol, 4,4′-thio-bis-(6-tert-butyl-m-cresol), butylated hydroxy anisole, butylated hydroxy toluene, bis(hydrogenated tallow alkyl), oxide; tris(2,4-ditert-butylphenyl)phosphite and 1,3,5 triazine-2,4,6 (1H, 3H, 5H)-trione, 1,3,5, tris((3,5 (1 dimethylethyl))-4-hydroxyphenyl)methyl. Typically, the antioxidant may be present in the filled or unfilled polymer sheet 120 in an amount less than or equal to approximately 2 wt % of the resin and/or the polymer sheet 120, such as between about 0.05-0.5 wt % of the resin and/or the polymer sheet 120.

The resin of the polymer sheet 120 may additionally include one or more viscosity modifiers and/or compatibilizers, such as, for example, olefins of higher or lower molecular weight than the resin discussed herein or ethylene maleic anhydride copolymer, to ensure proper flow and bonding of the resin within filler and polymers when applying onto a facecloth 111. The viscosity modifier may be present in an amount between about 0.1-3 wt % of the resin or the polymer sheet 120.

In certain embodiments, the resin of the polymer sheet 120 may additionally comprise one or more flame retardants, such as, but not limited to, aluminum trihydrate (ATH) or magnesium hydroxide (MgOH) for applications where flame-retardancy is desired. One or more flame retardants may be necessary to comply with applicable regulations regarding the installation and/or usage of carpet tiles in certain applications, for example, when such carpet tiles are installed in transportation vehicles (e.g., buses, aircraft, and/or the like).

### Method of Manufacture

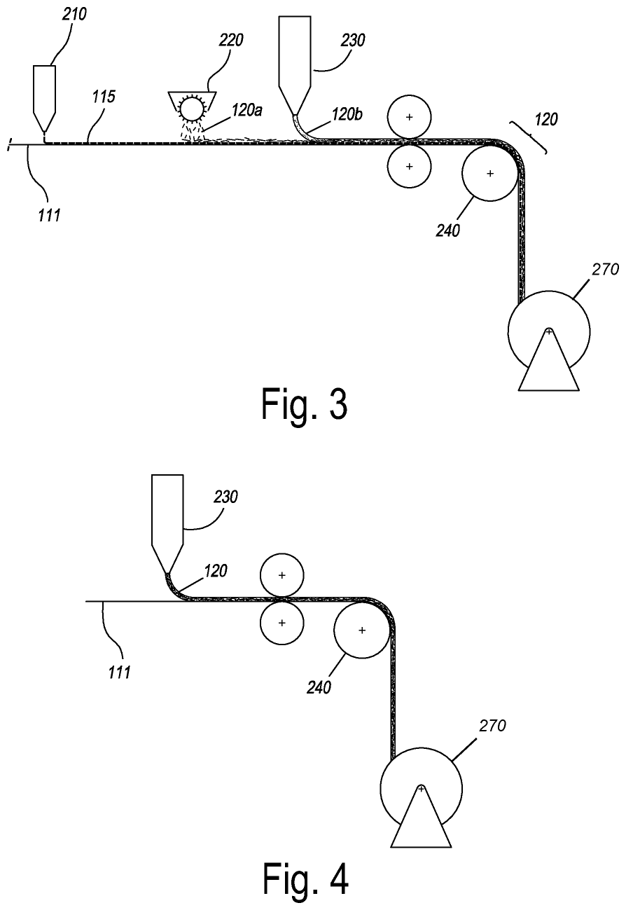

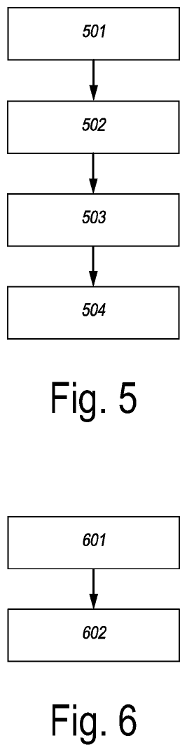

FIGS. 3 and 4 are schematic diagrams of a portion of example carpet or carpet tile manufacturing lines that may be utilized to construct a carpet or carpet tile 100 as discussed herein, and FIGS. 5 and 6 are flow charts of example methods for constructing the carpet or carpet tile 100 according to certain embodiments. As discussed herein, the carpet tiles 100 may be manufactured as a portion of a continuous web and later cut into desired tile shapes and sizes.

With respect to the embodiment shown in FIG. 3, the process begins by providing a facecloth 111, said facecloth having a top side 111a and a bottom side 111b. As discussed herein, the topside of the facecloth 111a may comprise face yarns 105 which ultimately form the top surface of the completed carpet or carpet tile 100. The facecloth 111 is advanced along a travel web in an inverted orientation with the bottom side 111b of the facecloth 111 facing upward, as indicated at Block 501 of FIG. 5. A polymer coating 115 is then applied to the bottom side 111b of the facecloth 111 so that the polymer coating has a top side and a bottom side, wherein the top side of the polymer coating is in contact with the bottom side of the facecloth as shown in Block 502. The facecloth and coating are then advanced along the travel path and a plurality of individually dispersed fibers 120a is applied onto the bottom side of the polymer coating as shown in Block 503. Next, a polymer-based resin 120b is extruded onto the bottom side of the polymer coating 115, thereby encapsulating the plurality of individually dispersed fibers 120a. The polymer-based resin 120b is then cooled and hardened, such as by chilling roller 240, forming a polymer sheet 120, comprising individually dispersed fibers 120a, encapsulated by resin 120b, as shown in Block 504. Optionally, the carpet or carpet tile may then continue into a take up roller 270 for storage.

With respect to the embodiment shown in FIG. 4, the process begins by providing a facecloth 111, said facecloth 111 having a top side 111a and a bottom side 111b. As discussed herein, the top side of the facecloth 111a may comprise face yarns 105 which ultimately form the top surface of the completed carpet or carpet tile 100. The facecloth 111 is advanced in an inverted orientation with the bottom side of the facecloth 111b facing upward, as indicated at Block 601 of FIG. 6. Next, a polymer-based resin comprising a plurality of individually dispersed fibers 120a is extruded onto the bottom side of the polymer coating 111b, thus forming a polymer sheet 120 as shown in block 602. The polymer sheet 120 may be cooled and hardened, such as by chilling roller 240, and the carpet or carpet tile may then continue into a take up roller 270 for storage.

In certain embodiments, the polymer-based resin is extruded onto the bottom portion of the facecloth or polymer coating by extruder head(s). The extruder head 230 may comprise a single, elongated extrusion die tip opening extending across the entire width of the facecloth 111 such that the resin is extruded as a continuous sheet from the extruder head 230. Alternatively, the resin may be extruded from a plurality of extruder heads 230 positioned across the width of the web travel path. The plurality of extruder heads may be spaced such that the resin flows together to form an at least substantially continuous extruded polymer sheet.

The facecloth 111 is advanced on a web travel path past one or more extruder heads 230 configured to extrude a continuous sheet of a polymer-based resin having an at least substantially uniform thickness onto the backside of the facecloth 111 to form the extruded polymer sheet 120, as indicated at Block 504. The one or more extruder heads 230 may be supplied by one or more extruders (e.g., single screw extruders and/or dual-screw extruders) configured to combine the various components of the resin prior to extrusion to form the extruded polymer sheet 120.

The facecloth 111 is advanced on a web travel path past one or more extruder heads 230 configured to extrude a continuous sheet of a polymer-based resin having an at least substantially uniform thickness onto the backside of the facecloth 111 to form the extruded polymer sheet 120, as indicated at Block 504. The one or more extruder heads 230 may be supplied by one or more extruders (e.g., single screw extruders and/or dual-screw extruders) configured to combine the various components of the resin prior to extrusion to form the extruded polymer sheet 120.

In certain embodiments, the extruder head 230 may comprise a single, elongated extrusion die tip opening extending across the entire width of the facecloth 111 such that the resin is extruded as a continuous sheet from the extruder head 230. Alternatively, the resin may be extruded from a plurality of extruder heads 230 positioned across the width of the web travel path. The plurality of extruder heads may be spaced such that the resin flows together to form an at least substantially continuous polymer sheet 120 having an at least substantially uniform thickness across the width of the facecloth 111.

The one or more extruder heads 230 may be supplied by one or more extruders (e.g., single screw extruders and/or dual-screw extruders) configured to combine the various components of the resin prior to extrusion to form the polymer sheet 120. Once combined, the extruders and one or more extruder heads 230 provide the at least substantially continuous sheet of resin onto the bottom surface of the facecloth 111 at a temperature between about 275-500 degrees Fahrenheit (about 135-260 degrees Celsius) and at a weight of between about 7.37-44.24 ounces per square yard (about 250-1500 grams per square meter).

In certain embodiments, the constructed carpet or carpet tile may pass through one or more chilling rollers 240 to cool and harden the polymer sheet 120. For example, the one or more chilling rollers 240 may be collectively configured to chill the polymer sheet 120 to approximately room temperature (between about 75-80 degrees Fahrenheit, or about 23.9-26.7).

The resulting carpet or carpet tiles 100 have improved flatness characteristics than similar carpet or carpet tiles having a plurality of backing layers.

### Example 1

One example of how the carpet or carpet tile comprising individually dispersed fibers can be manufactured is discussed herein. The example carpet or carpet tile comprises a facecloth 111 comprising a top side and a bottom side, the top side comprising face yarns.

The facecloth 111 is passed under a device 210 for applying the polymer coating 115. In some embodiments, said device is a slot die coater or a roll coater. The polymer coating 115 is applied onto the bottom side 111b of the facecloth 111. The facecloth is then advanced under a device 220 for uniform or approximately uniform application of the individually dispersed fibers 120a so that they are in contact with the bottom side of the polymer coating. In the pictured embodiment, the device 220 is a scatter coater. After the fibers are applied, the facecloth is passed under an extruder head 230 where a polymer-based resin is extruded so as to encapsulate the individually dispersed fibers. The resin is extruded in a continuous sheet onto the facecloth 111 to create an at least substantially uniform polymer sheet 120 having an at least substantially uniform thickness. The carpet is then passed through one or more chilling rollers 240 to cool and harden the polymer sheet 120. The carpet continues into a take up roller 270 for storage.

### Example 2

A carpet is manufactured according to a methodology discussed herein. A facecloth 111 comprising a top side and a bottom side travels with the bottom side facing up and is passed under an extruder head 230, where a polymer-based resin comprising individually dispersed fibers 120a is extruded onto a bottom side 111b of the facecloth 111 (such that the resin is extruded directly onto the bottom side 111b of the facecloth 111) to form the polymer sheet 120. The polymer-based resin comprising individually dispersed fibers is extruded in a continuous manner onto the bottom side 111b of the facecloth 111 to create an at least substantially uniform extruded polymer sheet 120 having an at least substantially uniform thickness. The polymer sheet 120 then passes through one or more chilling rollers 240 to cool and harden the polymer sheet 120, and the carpet continues into a take up roller 270 for storage.

### Alternative Embodiment

In alternative embodiments, the polymer sheet is prepared and cooled separately from the facecloth.

In an embodiment, the polymer-based resin and the individually dispersed fibers are mixed prior to extrusion of the resin. The mixture is cooled and hardened to as to form a polymer sheet.

In another embodiment, individually dispersed fibers are uniformly or substantially uniformly scattered onto a surface. The polymer-based resin is extruded on to the fibers, and cooled and hardened, forming a polymer-based sheet with encapsulated, individually dispersed fibers.

In both of these embodiments, the polymer sheet is then attached to the bottom side of the facecloth, or to a polymer coating on the bottom side of the facecloth. The polymer sheet may be affixed by any method known in the hard, including via adhesive, heat, or chemical bonding.

### CONCLUSION

Many modifications and other embodiments will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

1. A carpet or carpet tile comprising:
a facecloth, wherein a top side of the facecloth defines an upper surface of the carpet or carpet tile; and
a polymer sheet, wherein the polymer sheet defines at least a portion of a bottom surface of the carpet or carpet tile;
wherein said polymer sheet encapsulates a plurality of individually dispersed fibers, and wherein the individually dispersed fibers are not distributed uniformly throughout the polymer sheet.

2. The carpet or carpet tile of claim 1, wherein the plurality of individually dispersed fibers are configured with their length direction substantially parallel to the plane of the polymer sheet.

3. The carpet or carpet tile of claim 2, wherein the plurality of individually dispersed fibers comprise glass fibers, polymer fibers, or glass fibers and polymer fibers.

4. (canceled)

5. (canceled)

6. The carpet or carpet tile of claim 3, wherein the plurality of individually dispersed fibers are at least 0.5 inches in length.

7. The carpet or carpet tile of claim 3, wherein the plurality of individually dispersed fibers are at least 1.0 inches in length.

8. The carpet or carpet tile of claim 3, wherein the plurality of individually dispersed fibers are present in an amount of less than or equal to about 30 ounces per square yard.

9. The carpet or carpet tile of claim 8, wherein the carpet or carpet tile comprises a polymer coating, said polymer coating applied to the bottom side of the facecloth, and which is present in between said facecloth and said polymer sheet.

10. (canceled)

11. The carpet or carpet tile of claim 9, wherein said polymer coating comprises polyolefins having repeat units selected from the group consisting of propylene, ethylene, butene, and combinations thereof.

12. (canceled)

13. The carpet or carpet tile of claim 11, wherein said polymer sheet comprises polyolefins having repeat units selected from the group consisting of propylene, ethylene, butene, and combinations thereof.

14. The carpet or carpet tile of claim 13, wherein the polymer sheet has a thickness of between 0.01 and 20 mm.

15. The carpet or carpet tile of claim 14, wherein the polymer sheet is present in an amount of about 8-35 ounces per square yard.

16. (canceled)

17. (canceled)

18. The carpet or carpet tile of claim 15, wherein the facecloth comprises a primary backing and a plurality of face yarns extending through the primary backing.

19. (canceled)

20. The carpet or carpet tile of claim 18, wherein the plurality of individually dispersed fibers and the primary backing are positioned at most 10 mm apart from one another.

21. A method of manufacturing a carpet or carpet tile, the method comprising:
a) providing a facecloth having a top side and a bottom side; and
b) applying a polymer coating to the bottom side of the facecloth, so that the polymer coating has a top side and a bottom side, wherein said top side is in contact with the facecloth;
c) applying a plurality of individually dispersed fibers to the bottom side of the polymer coating; and
d) extruding a polymer-based resin onto the bottom side of the polymer coating, thereby encapsulating the plurality of individually dispersed fibers to form a polymer sheet, wherein the individually dispersed fibers are not distributed uniformly throughout the polymer sheet.

22. (canceled)

23. The method of claim 21, wherein said polymer coating comprises polyolefins having repeat units selected from the group consisting of propylene, ethylene, butene, and combinations thereof.

24. (canceled)

25. The method of claim 23, wherein the plurality of individually dispersed fibers comprise a plurality of glass fibers, a plurality of polymer fibers, or a plurality of glass fibers and a plurality of polymer fibers.

26. (canceled)

27. (canceled)

28. The method of claim 25, wherein the plurality of individually dispersed fibers are at least 0.5 inches in length.

29. The method of claim 25, wherein the plurality of individually dispersed fibers are at least 1.0 inches in length.

30. The method of claim 25, wherein the plurality of individually dispersed fibers are present in an amount of less than or about 30 ounces per square yard.

31. (canceled)

32. (canceled)

33. A carpet or carpet tile prepared by the method of claim 30.
